(19) United States
(12) Patent Application Publication
(10) Pub. No.: US 2006/0219182 A1
(43) Pub. Date: Oct. 5, 2006

(54) Dog leash assembly

(76) Inventor: Billy Pak Rabello, San Pedro, CA (US)

Correspondence Address: MARCIA A. DEVON;DEVON & ASSOCIATES, 400 OCEANGATE BLVD., SUITE 800, LONG BEACH, CA, 90802, US

(21) Appl. No.: 11/374,460

(22) Filed: Mar. 13, 2006

Related U.S. Application Data
(63) Continuation-in-part of application No. 10/691,892, filed on Oct. 23, 2003, now Pat. No. 7,044,080.

(51) Int. Cl. A01K 5/01

(52) U.S. Cl. 119/61.56

(57) ABSTRACT

A dog leash handle assembly is provided with containers for dog food and water which are removably attached to the assembly. Thus, the dog owner has a single assembly including the leash and provisions for the dog which are readily transported. The handle assembly also provides a place for the storage of clean up bags and other items. The handle assembly further includes has a mechanism for attaching to the loop handle of a typical dog leash.

The present application is a continuation-in-part of co-pending application Ser. No. 10/691,892.

### BACKGROUND OF THE INVENTION

1. Field of Invention

This invention pertains particularly to a dog leash handle with compartments for storage, a food dish and a water dish.

2. Background Information

The increasing popularity of dogs in urban population centers effectively require pet owners to walk the pets in public places. Walking the dog is often the only exercise the pet and the owner get on a daily basis. The owner must carry a number of supplies during these walks to satisfy their needs as well as the needs of the dog and society. Pet owners typically carry plastic waste disposal bags, keys, money, the dog leash and pet supplies such as water and food. This forces the pet owner to carefully organize these supplies prior to departure and to juggle them during the walk.

Local ordinances often require that pet owners pick up the solid waste left by their dog. Pet owners typically use plastic bags to pick up the waste. The pet owner must remember to carry an ample supply of bags when they begin their walk. The ease, convenience and economy with which the litter may be handled in a clean and sanitary manner directly affects the willingness of pet owners to retrieve and properly dispose of their pet's waste. Disposal of the bagged waste adds another significant item to those already carried by the owner.

Many owners would like to provide their dogs with some food and water particularly during longer walks or hiking. The owner must carry the food and water and the dishes necessary for dispensing the food.

Athletic ware and other comfortable walking clothes often have no reliable way to carry loose items such as money or keys. This forces the owner to carry these items in their hands. Carrying additional items such as lip balm, a whistle and/or pepper spray greatly increases the burden on the owner.

### BRIEF SUMMARY OF THE INVENTION

The present invention is a multi-compartmented dog leash handle assembly. The handle assembly has a compartment capable of carrying keys, money and/or plastic waste bags. The leash assembly also has provides for the easy transport of dog food and/or water. The leash assembly further includes a mechanism for attaching to the loop handle of a typical dog leash.

Plastic waste disposal bags can be stored in a compartment within a hollow portion in housing of the handle assembly. The compartment can be filled with plastic bags detachably connected end-to-end or with individual bags such as plastic grocery bags. Keys and/or money and other items can also be carried in the compartment. All of the items: clean-up bags, keys, money etc. can be accessed through an opening in the hollow housing.

A water dish and/or a food dish are provided which are removably attached to the housing of the leash assembly. A first dish is formed with male threads and a second dish with corresponding female threads. The dishes are therefore removably connected to each other and to the leash housing.

The owner can now carry several items in the same hand as the leash. The compartments and container dishes provide the owner with a reliable transportation device freeing them from the need to juggle multiple items and to control the dog (or other pet) while walking.

The foregoing has outlined the more pertinent and important features of the present invention. Additional features of the present invention will be described hereinafter, which form the subject of the claims. It should be appreciated by those skilled in the art that the disclosed specific embodiment might be readily utilized as a basis for modifying or designing other structures and methods for carrying out the same purposes of the present invention. It also should be realized by those skilled in the art that such equivalent constructions and methods do not depart from the spirit and scope of the inventions as set forth in the appended claims.

### BRIEF DESCRIPTION OF THE DRAWINGS

The invention will be more fully understood by reference to the following drawings that are for illustrative purposes only:

FIG. 1 is a side elevation view of a food or water container of the invention;

FIG. 2 is a side elevation view of a dividing spacer;

FIG. 3 is a side elevation view of a container assembly consisting of a dividing spacer attached to a food or water container;

FIG. 4 is a plan view of a holder;

FIG. 5 is a side elevation view of the holder;

FIG. 6 is a partially exploded side elevation view of a pet food container assembly consisting of a holder of FIG. 4 and two food or water containers of FIG. 1 with a resealable lid;

FIG. 7 is a side elevation view of the holder;

### DETAILED DESCRIPTION

A multi-compartmented dog leash assembly 5 is disclosed in FIG. 4 and FIG. 8 which may be attached to a conventional dog leash with a carabiner 80 as shown in FIG. 8. FIG. 8 a plan view of the leash assembly 5 with the leash 90 attached. A hand grip 60 is provided for the user to hold while walking the pet. The leash assembly may advantageously include at least one internal compartment suitable (on the interior of the housing and not shown) for carrying keys, money and/or plastic waste disposal bags. The internal compartment may be accessed by the opening 110 as shown in FIG. 4.

Containers or dishes 10 and 12 are provided to permit for the easy transport of food or water for the dog, or other pet, as part of the leash assembly. Other items may also be also be stored in the containers. The containers 10 and 12 are removably attached to each other and the housing 50.

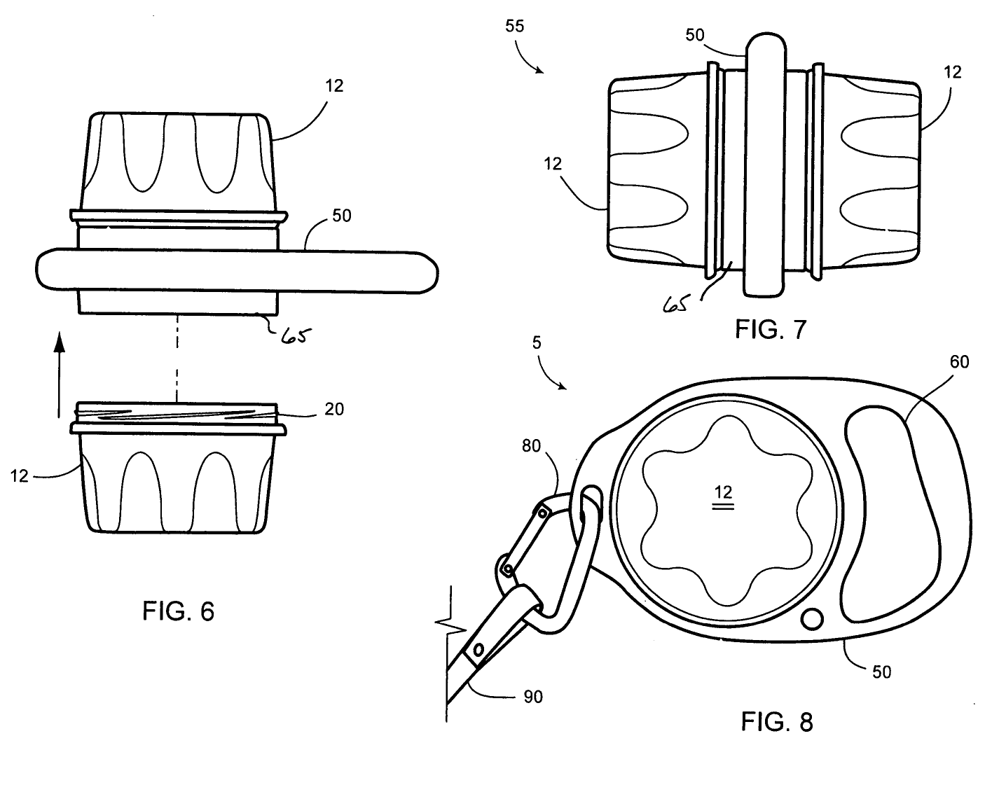

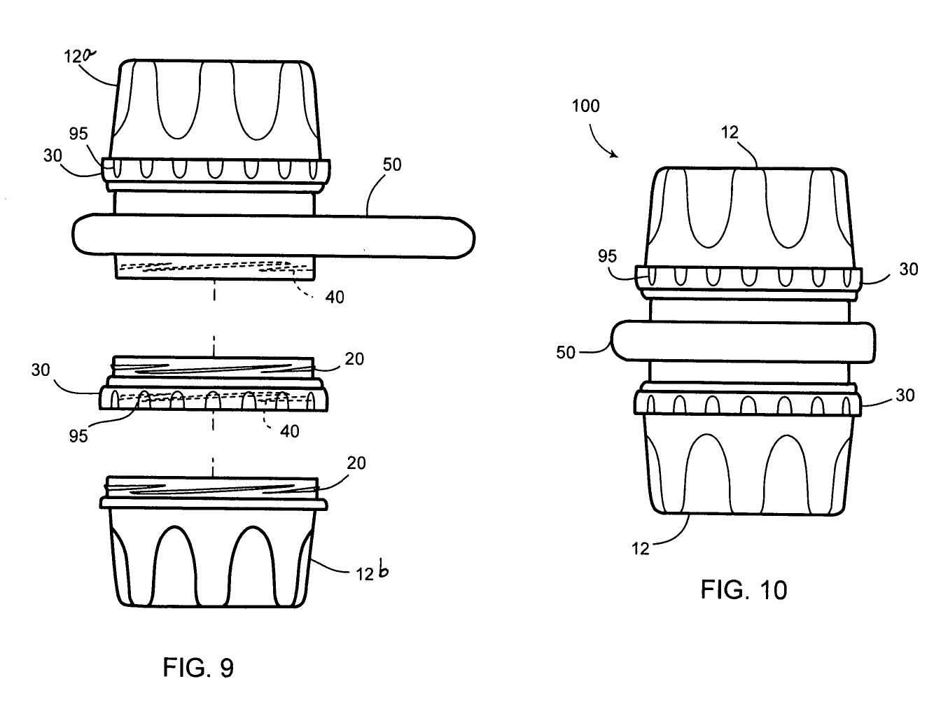

It will be appreciated that there are a variety of ways to attach the dishes to each other and to the housing. In the simplest embodiment, shown in FIG. 6 and FIG. 7, a food or water container assembly 55 comprises two dishes, an upper dish 12a and a lower dish 12b. Lower dish 12b is screwed into threads formed in lip 65 shown in FIG. 6. The housing 50 and the dish 12a may be one integrated unit of molded plastic with the dish 12b being detachable. The dish 12b shown in FIG. 6 are formed on their upper perimeters with male threads 20. Female threads 30 (not shown) may be formed in lip 65 to receive the male threads 20.

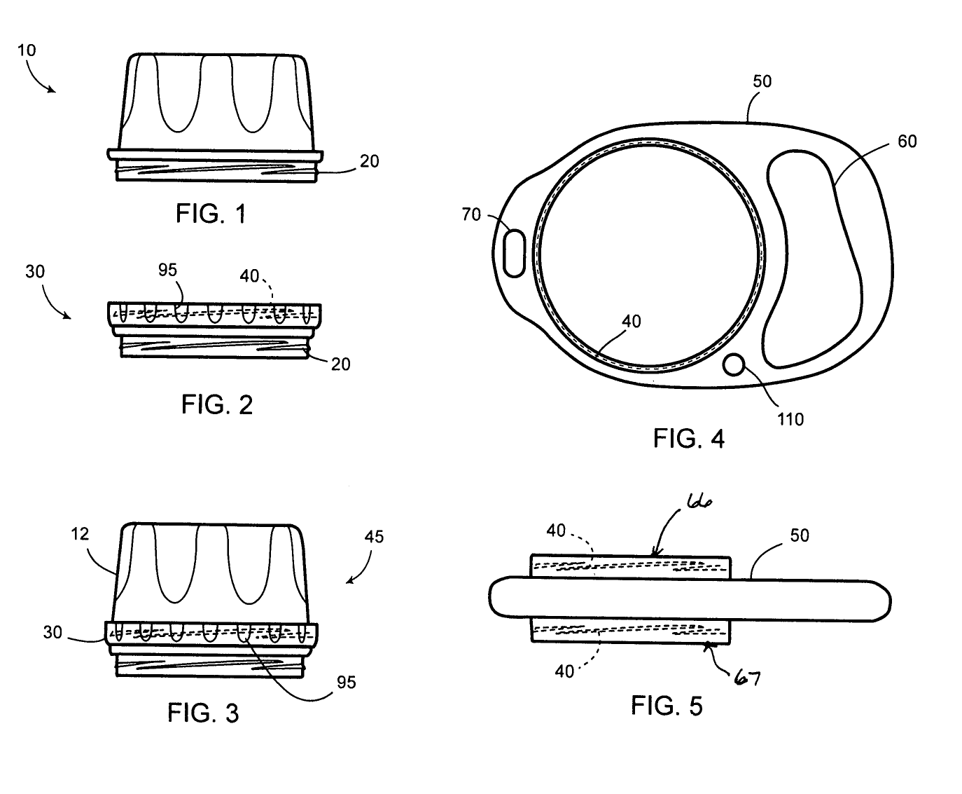

In another preferred embodiment, shown in FIG. 1-3 and FIG. 10, a dividing spacer 30 is provided to separate the containers. Thus, two separate items, e. g. food and water may both be carried without being mixed together in a single container because the dividing spacer 30 separates dish 10 from dish 12. In contrast, in the embodiment shown in FIG. 6, does not provide the dividing spacer 30. As shown in FIG. 2 and FIG. 10, the dividing spacer 30 may include male threads 20 and female threads 40 and is inserted between dish 10 and dish 12. The divider 30 also serves as a lid which seals the food and/or water.

In yet another embodiment shown in FIG. 5, the housing 50 is formed with a lips 66 and 67, with the lips including female threads 40 for receiving the male threads of containers 10 and 12 shown in FIG. 1 and FIG. 3. Lips 66 and 67 may also have male threads to correspond with female threads formed on the upper perimeter of dishes 10 and 12.

Indentions 95 are provided for the user's fingers to aid the assembly and disassembly of the food and water container assembly 100 with the housing 50 of the leash assembly.

In the preferred embodiment which includes the hollow housing 50 include an opening 110 to access an interior storage compartment (not shown) for placing dog waste disposal bags for the pet and/or other personal items. The compartment can be filled with plastic bags detachably connected end to end or individual bags such as plastic grocery bags.

A retractable leash mechanism can replace leash attachment mechanism and is located inside the housing (not shown). The retractable leash mechanism has a biased reel installed with its axel perpendicular to the outer surface of the first compartment at the container attachment point. The attached leash can extend or retract relative to the first compartment.

The present disclosure includes that contained in the present claims as well as that of the foregoing description. Although this invention has been described in its preferred forms with a certain degree of particularity, it is understood that the present disclosure of the preferred forms has been made only by way of example and numerous changes in the details of construction and combination and arrangement of parts may be resorted to without departing from the spirit and scope of the invention. Accordingly, the scope of the invention should be determined not only by the embodiments illustrated, but by the appended claims and their legal equivalents.

1. A dog leash assembly comprising:
a housing formed with a handle and attachment means;
a leash retainer mechanism adapted to be detachable from said housing;
first and second containers, each of said containers adapted to releasably connect to said attachment means and each container is also releasably connected to said housing such that the containers may be used to provide food and/or water for the dog when detached from said housing.

2. A dog leash assembly comprising:
a housing formed with a handle;
a holder formed with the housing, said holder formed with at least one lip, said lip having female threads;
a leash retainer mechanism adapted to be detachable from said housing;
at least one container, said containers having male threads for releasably attaching said container to said holder and said housing such that the containers may be used to provide food and/or water for the dog when detached from said housing.

3. A dog leash assembly comprising:
a housing formed with a handle, said housing including a holder having a first side and a second side, each side having female threads;
a first and a second container each having an upper perimeter, each container formed with male threads on said upper perimeters;
a dividing spacer having a first and second side, female threads formed on said first side and male thread on said second side, said spacer dividing the first container from the second container such that separate items may be held in said first and second container without mixing.

4. The dog leash assembly of claim 1 wherein the housing is hollow, forms an interior storage compartment and further includes an opening such that the user can access said storage compartment.

5. The dog leash assembly of claim 1 wherein the leash attachment mechanism is a carabiner.
